(19) United States
(12) Patent Application Publication
(10) Pub. No.: US 2018/0111407 A1
(43) Pub. Date: Apr. 26, 2018

(54) WEIGHTED WRITING INSTRUMENT SYSTEM

(71) Applicant: Pen Man Dan LLC, Centennial, CO (US)

(72) Inventors: Daniel J. Marin, Centennial, CO (US); Terry B. Marin, Centennial, CO (US)

(21) Appl. No.: 15/729,065

(22) Filed: Oct. 10, 2017

Related U.S. Application Data
(60) Provisional application No. 62/411,966, filed on Oct. 24, 2016.

(51) Int. Cl. B43K 23/004; B43K 5/00; B43K 7/00; G09B 11/00

(52) U.S. Cl. CPC B43K 23/004; G09B 11/00; B43K 7/005; B43K 5/005

(57) ABSTRACT

The disclosed technology includes methods and systems for facilitating handwriting for individuals who require assistance with their fine motor skills and pinch strength due to various conditions or injury. The methods and systems include writing instruments that may be used in order of succession based on improved or worsened fine motor skills. In one implementation, the method includes measuring a first writing capability of a user, selecting a first writing instrument with a barrel of a predetermined circumference and a predetermined weight selected based on the first writing capability of the user, using the selected first writing instrument for a first phase, measuring a second writing capability, detecting a first change between the first writing capability and the second writing capability, determining that the first phase is completed based on the detected first change, and selecting a second writing instrument responsive to determining the first phase is completed.

### CROSS-REFERENCE TO RELATED APPLICATIONS

The present application claims benefit of priority to U.S. Provisional Patent Application No. 62/411,966, entitled “Weighted Writing Instrument” and filed on Oct. 24, 2016, which is specifically incorporated by reference for all that it discloses and teaches.

### BACKGROUND

A variety of problems have contributed to writing difficulties for the general population, including adults and youth. An increase in the use of keyboards and a decrease in the use of traditional writing utensils has led to typing ailments and reduced penmanship. Additionally, a vast array of injuries, medical illnesses and ailments impact or prevent the ability of holding a writing instrument. For example, diminished thumb cartilage equates to loss of pinch strength. As a result, basic tasks such as holding and using a writing instrument may be difficult, painful, and even impossible.

### SUMMARY

The disclosed technology includes methods and systems for facilitating handwriting for individuals who require assistance with impaired fine motor skills due to various conditions or injury. The writing instruments described herein may be used in order of sequence succession based on improved or worsened fine motor skills during use of the disclosed systems and methods. In one implementation, the method includes measuring a first writing capability of a user, selecting a first writing instrument with a barrel of a predetermined circumference and a predetermined weight selected based on the first writing capability of the user, using the selected first writing instrument for a first phase, measuring a second writing capability, detecting a subsequent change between the first writing capability and the second writing capability, determining that the first phase is completed based on the detected first change, and selecting a second writing instrument responsive to determining the first phase is completed.

This Summary is provided to introduce a selection of concepts in a simplified form that are further described below in the Detailed Descriptions. This Summary is not intended to identify key features or essential features of the claimed subject matter, nor is it intended to be used to limit the scope of the claimed subject matter. These and various other features and advantages will be apparent from a reading of the following Detailed Descriptions.

### BRIEF DESCRIPTIONS OF THE DRAWINGS

FIG. 1 is a perspective view of a jumbo-sized weighted writing instrument.

FIG. 2 is a perspective view of a weighted writing instrument system during use.

FIG. 3 is a perspective view of a jumbo-sized weighted writing instrument.

FIG. 4 is a perspective view of a jumbo-sized weighted writing instrument during use.

FIG. 5 is a flowchart of example operation of using a weighted writing instrument system.

### DETAILED DESCRIPTIONS

The disclosed technology includes weighted writing instrument methods and systems aimed at resolving writing and pinch strength difficulties for the general population. Writing difficulties may be caused by injury or physical/medical conditions. For example, the aging population, including the exponentially growing baby boomer generation, may be suffering from thumb or finger pain. Such pain can morph into conditions, such as Carpal Metacarpal (CMC) and Osteoarthritis (O.A.). Basic tasks for sufferers of CMC and O.A., such as holding and using a writing instrument, may be both difficult and painful due to lack of pinch strength. With these types of conditions, the gripping process required in holding writing utensils, especially those of standard sizes reflective of small spherical/cylindrical diameter or circumference places additional strain on the muscles, nerves and ligaments necessary in the process of writing.

In yet another example, many individuals suffer from a vast array of medical illnesses and ailments that impact or prevent the ability of holding a writing instrument. That list includes, but is not limited to, Amyotrophic Lateral Sclerosis (ALS), Arthritis, Stroke, Cerebral Palsy, Spinal Cord Injury, Wrist Drop, Tendon Transfers, Numb Hands, Nerve Compressions, Claw Hand Syndromes, reconstruction of the hand, Repetitive Strain Injury (RSI), Carpal Tunnel Syndrome, Essential Tremor, Hereditary Tremors, Parkinson's Disease, Down Syndrome and other conditions. For example, a certain condition can place strain on the muscles, nerves and ligaments during the gripping process required in writing.

In yet another example, workforce demand requiring extended hours of daily computer use forces and reinforces repetitive motions in keyboarding and mouse usage. As a result, users suffer strains and numbing of the wrist and thumbs resulting in maladies (e.g., Carpal Tunnel Syndrome). In another example, today there is less emphasis on curriculum in schools for proper penmanship. Additionally, the lack of muscle use in a hand may lead to loss of fine motor control.

The disclosed technology includes weighted writing instruments that aid individuals to write with ease, assist with pinch strength problems and diminish difficulties and pain, which resonate from fingers, the hand, the forearm, and associated muscles and ligaments during the writing process. The weighted writing instrument may be used as a way to facilitate writing, and in some cases, may be used concurrently with physical therapy to address decreased fine motor control.

For purposes of this disclosure, a “writing instrument” is any object that can be used for writing or otherwise imparting text, an image, or other markings, on paper and other media by hand. Examples of a writing instrument include varieties of pencils, markers, styli, brushes, crayons, charcoals, chalks, scratchboard tools, and brushes. Each writing instrument has at least one barrel.

For purposes of this disclosure, the term “fine motor control” may refer to a level of coordination of small muscles in a user's hand tied to pinch strength and can be measured by observing or measuring a user's manual dexterity, such as grip (pinch strength), for example, when handwriting.

In some implementations, a weighted writing instrument includes a “substantially wide” or “jumbo-sized” barrel diameter and circumference. The terms “substantially wide” and “jumbo-sized” may be defined as at least a ¾″ diameter, and at least a 2¾″ (two and three-fourths inches) circumference.

In the disclosed weighted writing instrument methods and systems, a series of weighted writing instruments may be used in an order of succession to aid in fine motor control in a user's hand to facilitate handwriting. For example, a user who has suffered a stroke can begin using a weighted writing instrument with a larger circumference to improve manual dexterity with therapy as the user, on one end of a scale as the user cannot initially grasp small circumference writing objects. As the user's condition improves, as can occur in stroke sufferers, the user can use writing instruments with a smaller circumference on the other end of the scale.

In another example, a user who suffers from ALS may start with a writing instrument with a smaller circumference on one end of a scale. As the user's disability progresses and the grip ability of the user decreases, the user may begin using a larger second writing instrument in a weighted writing instrument system on the other end of the scale. An increase in the smaller circumference of the writing instruments will aid in grip pinch strength or grasp.

Depending on a user's condition, one or more than one writing instrument may be used in a course of treatment where a specific progression of writing instrument size is required based on the severity of the user's condition. For example, a stroke patient may begin to improve writing skills beginning with larger sized writing instrument, and throughout a course of therapy gradually change writing instruments progressing to a small sized writing instrument as a condition progresses on the various ends of the scale. In another example, an ALS patient may begin to improve writing skills beginning with smaller sized writing instrument, and throughout a course of therapy gradually change writing instruments progressing to a larger sized writing instrument as a condition progresses. However, in some cases, such as where a user has suffered a permanent injury or condition and their fine motor skills will not improve or worsen, the user may benefit from using one weighted writing instrument rather than multiple weighted writing instruments over several phases.

The weighted writing instrument may be weighted by a variety of configurations and means. The weight of each weighted writing instrument can increase in direct correlation to the increase in materials used in the manufacturing of the increased sizes of the writing instruments. The writing instrument can be weighted by the addition of metal or other heavy materials added to a center ring in the writing instrument, or by virtue of enhanced weight from the substrate being utilized in the barrel of the writing instrument. For example, using pine wood in the composition of the barrel is substantially less dense or lighter than the weight associated with iron wood of the same dimension. In other implementations, other components are contemplated to add weight to the writing instrument (e.g., a gripping component added to the barrel).

The exterior casing of the barrel(s) can be weighted, uniformly or in certain parts of the barrels. In some implementations with more than one barrel, only one barrel may be weighted. The barrel may be weighted by a variety of components (e.g., metal, etc.). In some implementations, the weight of the barrel can be modified. For example, different metal components may be added and taken out of the barrel depending on the need of the user and in some cases, the progression of a certain condition. If the handwriting of a user is improving, weights may be taken out of the barrel as the skills of the user improves.

In some implementations, a writing instrument may be contoured and/or have a certain shape (e.g., spherical, cylindrical, square, triangular, etc.). In some implementations, a writing instrument may comprise of different materials (e.g., wood, plastic, metal, etc.). In some implementations, there may be more than one barrel, such as two barrels, and the two barrels can be shaped the same shape or different shapes. The barrels can be separated by a central ring, connector or other component, and one barrel can be connected to another connector or directly to a nib or roller ball assembly.

In some implementations, a weighted writing instrument may include an abrasive grip or exterior covering to include, but not be limited to leather, rubber, fabric, 3D printed material or foam products that aids individuals with a vast array of writing difficulties to transition from gross grasp to prehension fine motor coordination. For example, in some implementations, the barrel may include a rough surface.

In some implementations, a weighted writing instrument may include up to two longitudinal barrel segments that can house a cartridge. The weighted writing instrument may include a replaceable cartridge. In some implementations, the barrel of a weighted writing instrument may include a crayon. In some implementations, the barrel of a weighted writing instrument may include a filler (e.g., charcoal, graphite, etc.). The writing instrument may include independent top and bottom supports that hold the split barrel together.

In some implementations, an assistive tool may be attached to or configured into the weighted writing instruments (e.g., a magnifying glass, a light, etc.). The assistive tool may be a permanently attached or removable.

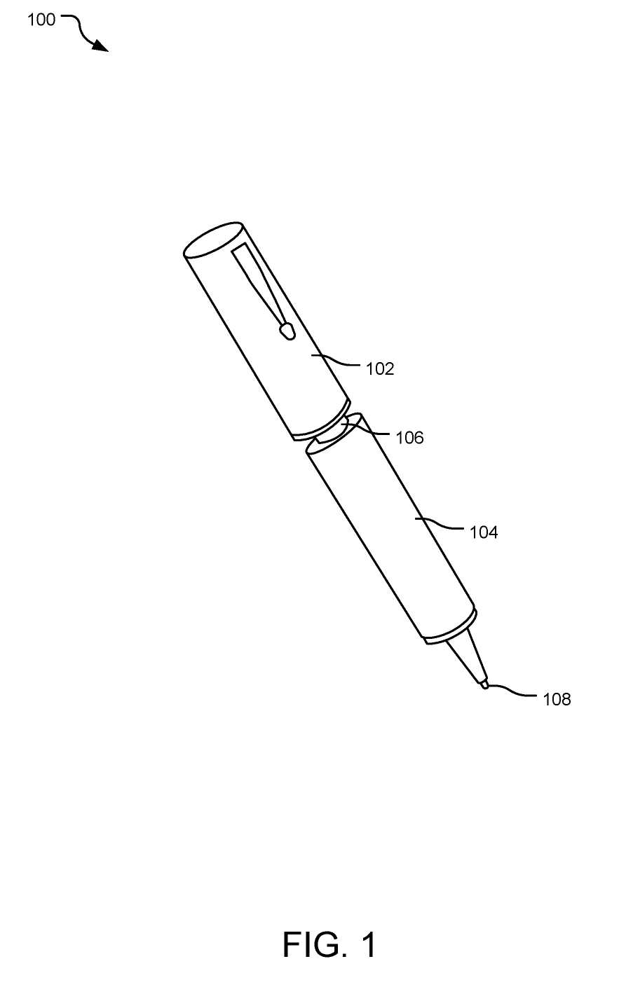

FIG. 1 is a perspective view of a jumbo-sized weighted writing instrument 100. In this implementation, there are two barrels (e.g., a first barrel 102 and a second barrel 104) in the writing instrument 100. In other implementations, there may be only one barrel or more than two barrels.

At least one of the first barrel 102 or the second barrel 104 may have a predetermined circumference and a predetermined weight selected based on a writing capability of a user. In this implementation, the circumferences (and thus, the diameters) of the first barrel 102 and the second barrel 104 in the writing instrument 100 are the same. In other implementations, the circumference of the first barrel 102 and the second barrel 104 in the writing instrument may be different.

The diameter of the jumbo-sized weighted (or “substantially wide”) writing instrument 100 may range from ¾″ to 1⅞″, with corresponding circumferences from 2¾″ to 5 ⅝″ or greater, respectively, to accommodate the various needs of the user. The weight of the weighted writing instrument 100 is in a range of approximately 56-131 grams.

The jumbo-sized weighted writing instrument 100 in FIG. 1 is designed to be used in either the left hand or the right hand without modification to the instrument. However, in some implementations, the jumbo-sized weighted writing instrument 100 may be configured specifically to left-hand or right-hand users.

A center ring 106 is shown located between the first barrel 102 and the second barrel 104. Depending on positioning, the center ring 106 can provide an area for a resting or cradle support for a user's hand. In some implementations, the center ring may be weighted (e.g., with heavy metal), and the weight may be interchangeable with a center ring 106 of a different weight, depending on user need. In some implementations, the height of the center ring 106 (or the distance between the first barrel 102 and the second barrel 104) may be predetermined based on a user need. In FIG. 1, a tip 108 is also shown, at the end of the second barrel 104, where ink is dispersed.

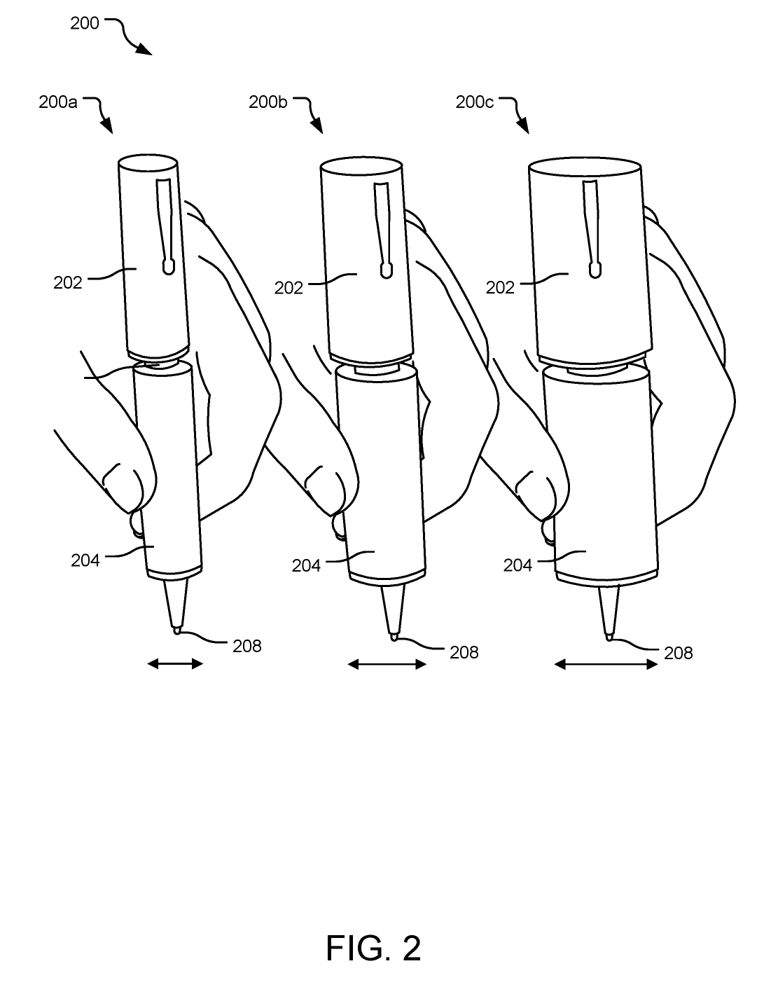

FIG. 2 is a perspective view of a weighted writing instrument system 200 during use. As shown, the weighted writing instrument system 200 includes three weighted writing instruments (e.g., weighted writing instrument 200a, weighted writing instrument 200b, and weighted writing instrument 200c). In some implementations, a weighted writing instrument system 200 may have more or less than three weighted writing instruments.

In FIG. 2, there are two barrels in each weighted writing instrument (e.g., a first barrel 202 and a second barrel 204). In other implementations, there may be more or less than two barrels in the weighted writing instrument. In this implementation, the width of the two barrels in each writing instrument is the same size. In other implementations, the width of the two barrels in each weighted writing instrument may be of different size. The diameters of the substantially wide or jumbo-sized weighted writing instruments may range from ¾′ to 1⅞″, with corresponding circumferences from 2¾″ to 5⅝″ or greater, respectively, to accommodate the various needs of the user.

In FIG. 2, the width of the barrels in the weighted writing instruments 200a, 200b, and 200c increase in succession from the smallest width in weighted writing instrument 200a, to a larger width in weighted writing instrument 200b, and to an even larger in weighted writing instrument 200c.

Depending on a user's injury or physical/medical condition, the order of succession of use of the weighted writing instrument system 200 can differ. For example, a user who has suffered a stroke can be assisted to improve their manual dexterity with therapy as the user begins using a writing instrument with a larger circumference on one end of a scale as the user cannot initially grasp writing objects with a smaller circumference on the other end of the scale.

For purposes of this disclosure, a scale may be defined as a progression or graduated series in the weighted writing instrument system. For example, a scale may start at the largest weighted writing instrument and end at the smallest weighted writing instrument in a system, or vice versa. Referring to FIG. 2, for illustration, as a user's disability improves, the user can move from larger weighted writing instruments to smaller weighted writing instruments. Specifically, a user suffering from a stroke may begin the weighted writing instrument system 200 with weighted writing instrument 200c and work down the scale towards weighted writing instrument 200a.

In another example, the scale may be more fine-tuned to specific abilities correlating to multiple weighted writing instruments, and thus, there may be more defined and measurable points on a scale for each weighted writing instrument.

Once a first phase of writing improvement is completed, and if the user has an improved change in fine motor control, the user may use weighted writing instrument 200b in a second phase, which has a larger circumference. Upon further improved change in fine motor control, the user may then use weighted writing instrument 200a in a third phase of the weighted writing instrument system 200. If no change in fine motor control is detected after use of a weighted writing instrument, the user may continue using the same weighted writing instrument until there is indication for a larger or smaller weighted writing instrument.

In another example, a user who suffers from ALS may start with a “normal” grip using a writing instrument with a smaller circumference but as the user's disability progresses and the grip ability of the user decreases, the user may benefit from the option to use a system with weighted writing instruments increasing in circumference on one of end of a scale as larger weighted writing instruments will aid in grip or grasp over time on the other end of the scale. Thus, referring to FIG. 2, a user suffering from ALS may begin the weighted writing instrument system 200 with weighted writing instrument 200a.

Once a first phase of writing is completed, and if the user has a worsened change in fine motor control, the user may use weighted writing instrument 200b in a second phase. Upon further worsened change in fine motor control, the user may then use weighted writing instrument 200c in a third phase of the weighted writing instrument system 200.

The arrows in FIG. 2 indicate potential movement during use of the weighted writing instruments and is displayed for illustrative purposes only. In FIG. 2, a tip 208 is also shown, at the end of the second barrel 204, where ink is dispersed.

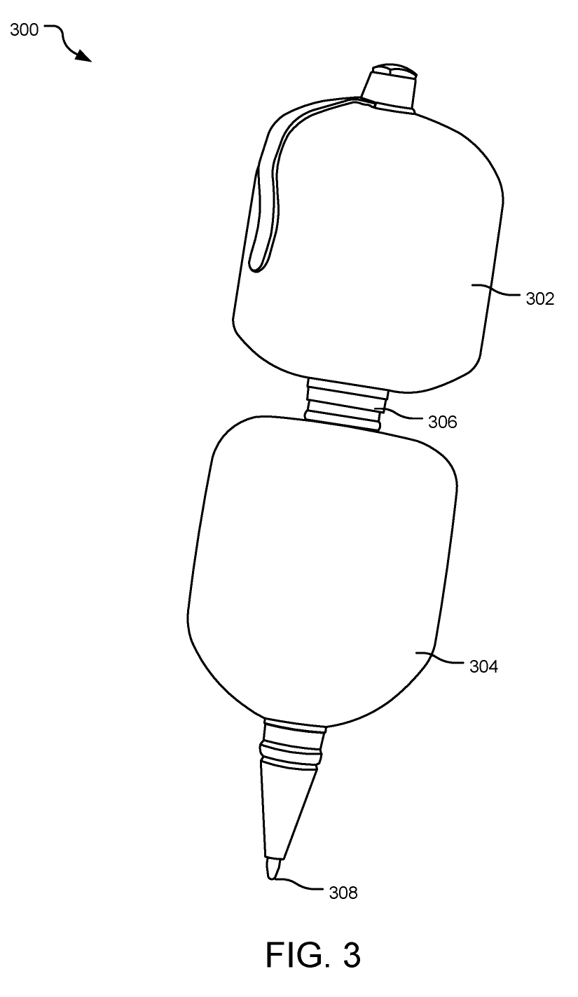

FIG. 3 is a perspective view of a jumbo-sized weighted writing instrument 300. In this implementation, there are two barrels (e.g., a first or top barrel 302 and a second or bottom barrel 304) in the writing instrument 300. In other implementations, there may be only one barrel or more than two barrels. In this implementation, the circumference of the two barrels in the writing instrument is the same size. In other implementations, the circumference of the two barrels in the writing instrument may be of different size.

The diameters of the barrels of the jumbo-sized weighted (or “substantially wide”) writing instrument 300 is approximately 1 11/16″, with corresponding circumferences of 5¾″. The weight of the writing instrument 300 is approximately 136 grams.

In this implementation, when the ink reservoir has been exhausted, the bottom barrel 304 of the writing instrument 300 is held and the top barrel 302 is pulled in an upward motion to expose a plastic ink barrel that can be unscrewed and replaced. In another implementation, there may be a metal cartridge that can be replaced. The top barrel 302 and the bottom barrel 304 of the jumbo-sized weighted writing instrument 300 can be rotated opposite of each other to expose the writing element of the jumbo-sized weighted writing instrument 300.

A center ring 306 is shown located between the first barrel 302 and the second barrel 304. In some implementations, the center ring 306 may be weighted, and the weight may be interchangeable with a center ring 306 of a different weight, depending on user need. In some implementations, the height of the center ring 306 (or the distance between the first barrel 302 and the second barrel 304) may be predetermined based on a user need. In FIG. 3, a tip 308 is also shown, at the end of the second barrel 304, where ink is dispersed.

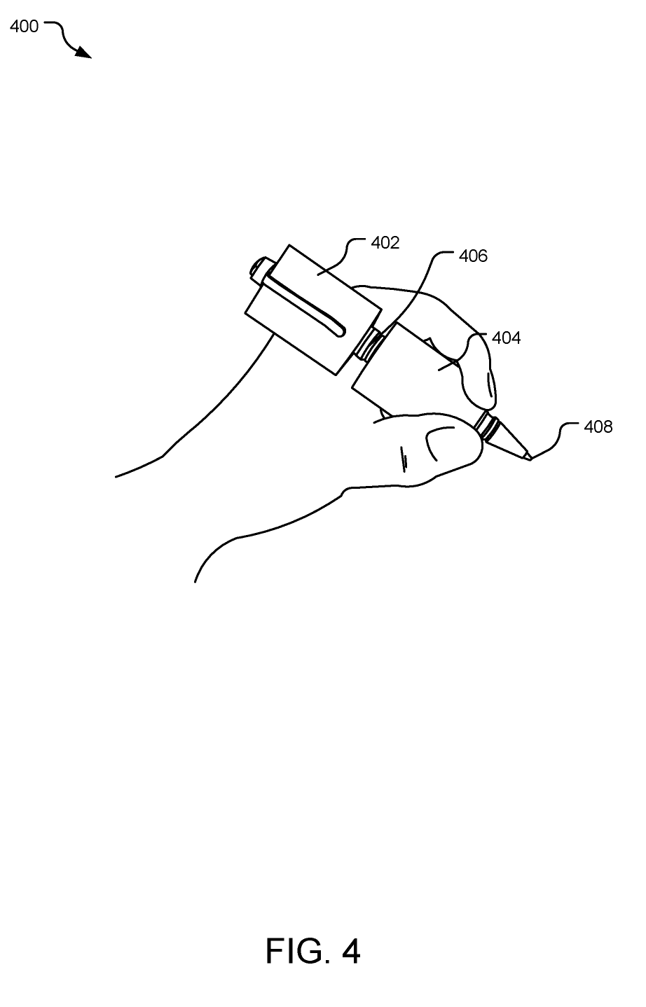

FIG. 4 is a side view of a jumbo-sized weighted writing instrument 400 in use. In this implementation, there are two barrels (e.g., a first or top barrel 402 and a second or bottom barrel 404) in the writing instrument 400. In other implementations, there may be only one barrel or more than two barrels. In this implementation, the circumference of the two barrels in the writing instrument is the same size. In other implementations, the circumference of the two barrels in the writing instrument may be of different size. The diameters of the barrels of the jumbo-sized weighted (or “substantially wide”) writing instrument 400 is approximately 1 11/16″, with corresponding circumferences of 5¾″. The weight of the writing instrument 400 is approximately 136 grams.

In this implementation, the top and bottom of the overall length of the jumbo-sized weighted writing instrument 400 is approximately 5½ inches and is coupled or held together at or near the center of the instrument by a pressure fit. Other lengths and other configurations are contemplated.

In this implementation, when the ink reservoir has been exhausted, the bottom barrel 404 of the writing instrument 400 is held and the top barrel 402 is pulled in an upward motion to expose a plastic ink barrel that can be unscrewed and replaced. In another implementation, there may be a metal cartridge that can be replaced. The top barrel 402 and the bottom barrel 404 of the jumbo-sized weighted writing instrument 400 can be rotated opposite of each other to expose the writing element of the jumbo-sized weighted writing instrument 400.

A center ring 406 is shown located between the first barrel 402 and the second barrel 404. In some implementations, the center ring 406 may be weighted, and the weight may be interchangeable with a center ring 406 of a different weight, depending on user need. In some implementations, the height of the center ring 406 (or the distance between the first barrel 402 and the second barrel 404) may be predetermined based on a user need. In FIG. 4, a tip 408 is also shown, at the end of the second barrel 404, where ink is dispersed.

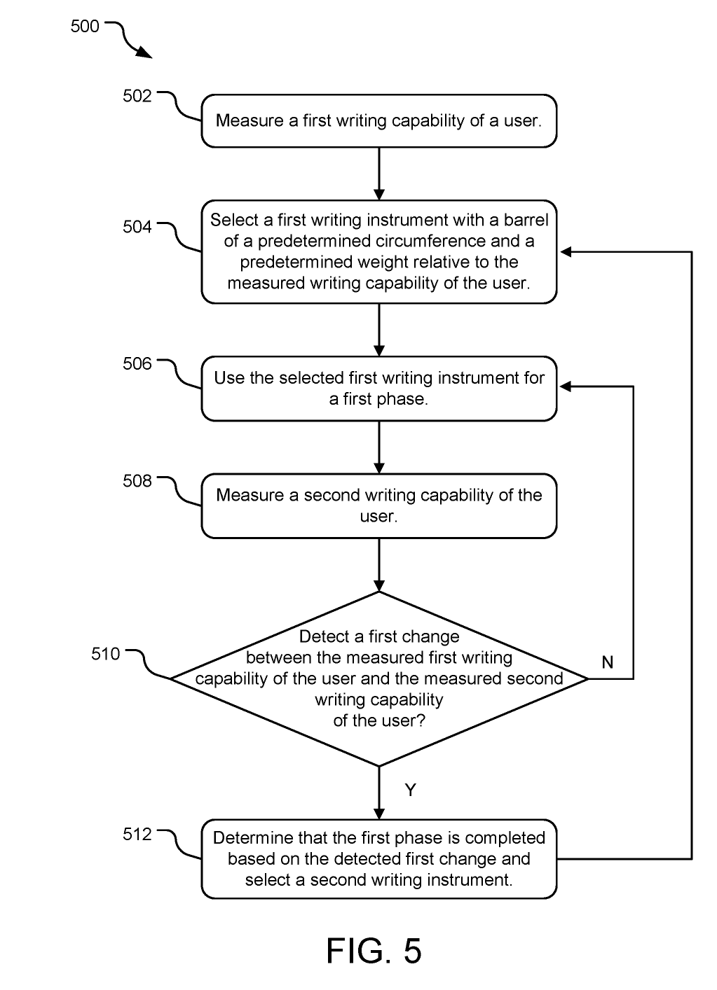

FIG. 5 is a flowchart of example operations 500 for using a weighted writing instrument system. In the disclosed weighted writing instrument systems, a user may use one or more writing instruments to assist the user's fine motor control in an order of succession specific to user need.

An operation 502 measures a first writing capability of a user. The measurement of the writing capability of the user may be an assessment that includes asking the user specific questions regarding their writing capability. For example, a first writing instrument may be given to the user and the user may test their use of the writing instrument for weight, comfort, and writing skill. The measurement may be a verbal response or the measurement may be an observation based on a writing test or performed by a hand therapist. In another example, a questionnaire may be directed to the user, which includes specific questions relative to an injury or physical condition of the user. In yet another example, a professional therapist or physician may perform an assessment. The assessment may include determining the grip or pinch strength of the individual. Another determining factor may be the distance or possible gap in the observation of the user's pinch capability to determine the girth of the writing instrument the individual can control.

An operation 504 selects a first writing instrument with a barrel of a predetermined circumference and a predetermined weight selected based on the measured writing capability of the user. In some implementations, selection may include selecting a first writing instrument in a series in a specific writing instrument system. In some implementations, as provided above, a weighted writing instrument may be selected based on pinch strength measurements and pinch gap determination for control of a weighted writing instrument.

An operation 506 uses the selected first writing instrument for a first phase. In some implementations, a first phase may be a predetermined length of time. In some implementations, a first phase may be a certain amount of handwriting completed (e.g., a therapeutic workbook). Other parameters for what a “phase” entails are contemplated (e.g., specific skill measurements).

An operation 508 measures a second writing capability of the user. The second writing capability may be measured the same way the first writing capability of the user was measured. In some implementations, other measurements may be introduced. For example, the first writing capability measurement may be geared more towards comfort and positioning and the second writing capability measurement may be geared more towards penmanship.

An operation 510 detects whether there is a first change between the measured first writing capability of the user and the measured second writing capability of the user. A detected change could be a predetermined threshold of writing capability. For example, standards or milestones may be implemented to denote when a predetermined threshold is met specific to detailed handwriting techniques. In another example, a detected change may be visual observations on improved or worsening penmanship.

If the operation 510 detects a first change between the measured first writing capability of the user and the measured second writing capability of the user, an operation 512 determines that the first phase is completed based on the detected first change and selects a second writing instrument with a barrel of a predetermined circumference and a predetermined weight selected based on the measured writing capability of the user. In some implementations, a determination that the first phase is completed is based on the detected first change on one end of a scale for the first writing instrument. In such instance, the second writing instrument may be selected based on an end of a scale for the second writing instrument.

Operation 504 may occur again with respect to the second writing instrument. If operations 504-510 results in a detected change following the second phase, an operation 512 may result in selection of a third writing instrument, and operations 504 may occur again with respect to the third writing instrument. In some weighted writing instrument systems, there are three writing instruments, but any number of writing instruments may be used depending on user need.

If the operation 510 detects there is no change between the measured first writing capability of the user and the measured second writing capability of the user, an operation 506 may occur, which continues using the selected first writing instrument for a first phase.

In one example, the first detected change may be a worsened fine motor control. In such instance, a second writing instrument with a larger circumference than the circumference of the first writing instrument may be selected. In another example, the first detected change may be an improved fine motor control. In such instance, a second writing instrument with a smaller circumference than the circumference of the first writing instrument may be selected.

In some implementations, rather than changing writing instruments, the weight of at least one barrel in the first writing instrument may be changed based on a first detected change.

The logical operations making up the embodiments of the invention described herein are referred to variously as operations, steps, objects, or modules. Furthermore, it should be understood that logical operations may be performed in any order, adding or omitting operations as desired, unless explicitly claimed otherwise or a specific order is inherently necessitated by the claim language. Additionally, the operations may be performed iteratively. The operations 500 may be repeated to establish progress goals based on past performance for determination of moving through the weighted writing instrument system. For example, operations 502 and 508 may occur iteratively, re-checking measurements relative to pinch strength, gap, and enhanced control of the weighted writing instrument. Measuring writing capability may include gauging progress in ease of motion and writing instrument control, as well as the restoration of user confidence in ability to progress.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet other embodiments without departing from the recited claims.

What is claimed is:

1. A method for facilitating handwriting, comprising:
measuring a first writing capability of a user;
selecting a first writing instrument with a barrel of a predetermined circumference and a predetermined weight selected based on the measured writing capability of the user;
using the selected first writing instrument for a first phase;
measuring a second writing capability of the user;
detecting a first change between the measured first writing capability of the user and the measured second writing capability of the user;
determining that the first phase is completed based on the detected first change; and
selecting a second writing instrument responsive to determining the first phase is completed.

2. The method of claim 1, further comprising:
using the selected second writing instrument for a second phase;
measuring a third writing capability of a user;
detecting a second change between the measured second writing capability of the user and the measured third writing capability of the user;
determining that the second phase is completed based on the detected second change; and
selecting a third writing instrument responsive to determining the first phase is completed.

3. The method of claim 1, wherein the first detected change is worsened fine motor control.

4. The method of claim 3, further comprising:
selecting the second writing instrument with a larger circumference than the circumference of the first writing instrument responsive to determining worsened fine motor control.

5. The method of claim 1, wherein the first detected change is improved fine motor control.

6. The method of claim 5, further comprising:
selecting the second writing instrument with a smaller circumference than the circumference of the first writing instrument responsive to determining improved fine motor control.

7. The method of claim 1, further comprising:
changing the weight of the barrel in the first writing instrument based on a first detected change.

8. The method of claim 1, wherein the predetermined circumference of the barrel measures at least 2¾″.

9. The method of claim 1, wherein the predetermined weight of the barrel is in a range of approximately 56-131 grams.

10. A writing instrument comprising:
at least one barrel, wherein the at least one barrel has a predetermined circumference and a predetermined weight selected based on a measured writing capability of the user.

11. The writing instrument of claim 10, wherein the circumference of the first barrel and the second barrel are different.

12. The writing instrument of claim 10, wherein the weight of at least one barrel can be modified.

13. The writing instrument of claim 12, wherein at least one of a diameter of the first barrel or the second barrel measures at least ¾″.

14. The writing instrument of claim 12, wherein at least one of the circumferences of the first barrel or second barrel measures at least 2¾″.

15. The writing instrument of claim 12, wherein the weight of the writing instrument is in a range of approximately 56-131 grams.

16. A system comprising:
at least three writing instruments, each of the writing instruments used in an order of succession and each of the writing instruments including:
a barrel, wherein a predetermined barrel size and a predetermined weight of the barrel is selected based on a measured writing capability of the user.

17. The system of claim 16, wherein a diameter of a first barrel measures at least ¾,″ a diameter of a second barrel is greater than the first barrel, and a diameter of a third barrel is greater than the second barrel.

18. The system of claim 16, wherein a circumference of first barrel measures at least 2¾,″ a circumference of a second barrel is greater than the first barrel, and a circumference of a third barrel is greater than the second barrel.

19. The system of claim 16, wherein the order of succession for using the writing instruments is based on worsened fine motor control.

20. The system of claim 16, wherein the order of succession for using the writing instruments is based on improved fine motor control.
